(19) United States
(12) Patent Application Publication
(10) Pub. No.: US 2007/0120664 A1
(43) Pub. Date: May 31, 2007

(54) Fire hydrant locating system

(75) Inventors: Robert D. Bilbrey, Albertville, AL (US); James D. Abel, Arab, AL (US); Jeffery S. Culbert, Albertville, AL (US)

Correspondence Address: HARNESS, DICKEY & PIERCE, P.L.C., P.O. BOX 828, BLOOMFIELD HILLS, MI, 48303, US

(73) Assignees: SYNCRO CORPORATION, ARAB, AL (US); MUELLER COMPANY, DECATUR, IL (US)

(21) Appl. No.: 11/291,138

(22) Filed: Nov. 30, 2005

(51) Int. Cl. G08B 1/08

(52) U.S. Cl. 340/539.32

(57) ABSTRACT

This invention relates to a fire hydrant locating system which includes a hydrant locator that facilitates the location of a hydrant by firefighters, particularly in an emergency vehicle such as a fire engine. The hydrant locator as secured to the hydrant cylinder has a low profile. The hydrant locating system includes a transmitter adapted to be located in the emergency vehicle. Upon actuation of a switch in the transmitter in the emergency vehicle a receiver-signal generator in the hydrant locator will be activated to set off strobe lights to alert firefighters of the hydrant location. The receiver-signal generator in the hydrant locator includes a strobe light structure. The transmitter can be set such that when actuated it will activate only those hydrant locators within a preselected range such as approximately 1500 feet.

### FIELD OF THE INVENTION

The present invention relates to a system for facilitating the remote location of fire hydrants by personnel in emergency vehicles.

### BACKGROUND OF THE INVENTION

This invention relates to a fire hydrant locator unit that facilitates the location of a hydrant by firefighters, particularly in a fire engine (firetruck) or emergency personnel in other emergency vehicles. The hydrant locator unit as secured to the hydrant cylinder has a low profile. A selectively actuable switch in an RF (radio frequency) transmitter in an emergency vehicle will activate the transmitter to send an RF signal to an RF receiver in the hydrant locator unit to set off strobe lights in the hydrant locator to alert the firefighters or other emergency personnel of the hydrant location.

In fighting fires, time is a crucial factor and precious time is often wasted in finding a desirably located fire hydrant. Ideally, firefighters want to hook up to the hydrant closest to the fire for purposes of having maximum water pressure and minimizing the required hose length and time to bring the hose outlet to the fire. Unfortunately, the hydrants are often somewhat hidden by their surroundings such as bushes, trees, vehicles, etc. In some instances a vertical flag or similar physical locator has been secured to the hydrant to assist sighting by emergency personnel. These flags may fail in their main purpose since they too can be obscured by surroundings or be inadvertently detached. In addition they may not be readily visible at night. Area maps which show the location of hydrants may be of little help in some situations, including night time hours, and in addition firefighters may not be aware of the precise fire location or may be unfamiliar with the neighborhood.

As a matter of interest a hydrant locator unit is shown in U.S. Pat. No. 6,758,160 issued Jul. 6, 2004. That patent generally discloses a hydrant locator unit which provides a flashing light signal in response to a signal from a remote transmitter. The only significant details disclosed are in the description of a belt like arrangement for connection of the hydrant locator unit to a fire hydrant. Thus this patent does not show or suggest the unique system of the present invention.

The prior art fails to disclose the unique hydrant locating system disclosed herein which includes a hydrant locator unit with a low profile mounting on a hydrant and which has strobe lights which can be remotely activated by a unique system from an emergency vehicle.

### SUMMARY OF THE INVENTION

The hydrant locating system of the present invention comprises a hydrant locator unit and a transmitter, actuator. The hydrant locator unit is adapted to be fixed to the cylinder of the hydrant below the crown and has a low profile and thus does not interfere with access to the fire hydrant, such as for hose attachment to the hydrant for water. The hydrant locator unit comprises a receiver, locator with an RF receiver mounted internally in a housing and is adapted to activate a plurality of LEDs in a strobe light array upon receipt of a remote RF signal from an RF transmitter in the transmitter, actuator in the emergency vehicle, i.e. fire engine (firetruck).

In use, a transmitter of the transmitter, actuator which is in an emergency vehicle, is selectively actuable by an operator by a switch to send a signal to a receiver of a receiver, locator in the hydrant locator unit. In some cases, the transmitter can be set to activate only those hydrant locator units within a given forward range, such as approximately 1500 feet.

The receiver, locator is powered by batteries and is designed to continuously, periodically activate the receiver on, to a wake mode, and off, to a sleep mode, during an idle condition to enable it to receive activating signals at any time from the transmitter during an emergency condition. Such periodic cycling preserves power and thereby provides an extended battery life.

The hydrant locator unit has a unique housing structure in which the receiver, locator is contained. The housing structure facilitates attachment to a fire hydrant.

Accordingly, an object of this invention is to provide a new and improved fire hydrant locating system.

Another object of this invention is to provide a new and improved fire hydrant locating system that includes a hydrant locator unit with a receiver, locator having an RF receiver which is remotely actuable by an RF signal from a transmitter, actuator for activating strobe lights to facilitate visual location.

A further object of this invention is to provide a new and improved fire hydrant locating system including a low profile hydrant locator unit having a receiver, locator with strobe lights that are activated by an RF receiver in the receiver, locator in the hydrant locator unit in response to an RF signal from a transmitter in a transmitter, actuator in an emergency vehicle. The transmitter, actuator can be selectively actuable by an operator by a switch.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of the transmitter, actuator, for use in an emergency vehicle, in the fire hydrant locating system of the present invention and has a transmitter module for remotely activating a hydrant locator unit on the fire hydrant;

FIG. 2 is a block diagram of the operating circuit of the receiver, locator in a hydrant locating unit of the fire hydrant locating system of the present invention and which is adapted to be secured to a fire hydrant and which has a receiver module adapted to be remotely actuated by the transmitter, actuator;

FIG. 3 is a frontal pictorial view of the hydrant locator unit of the fire hydrant locating system;

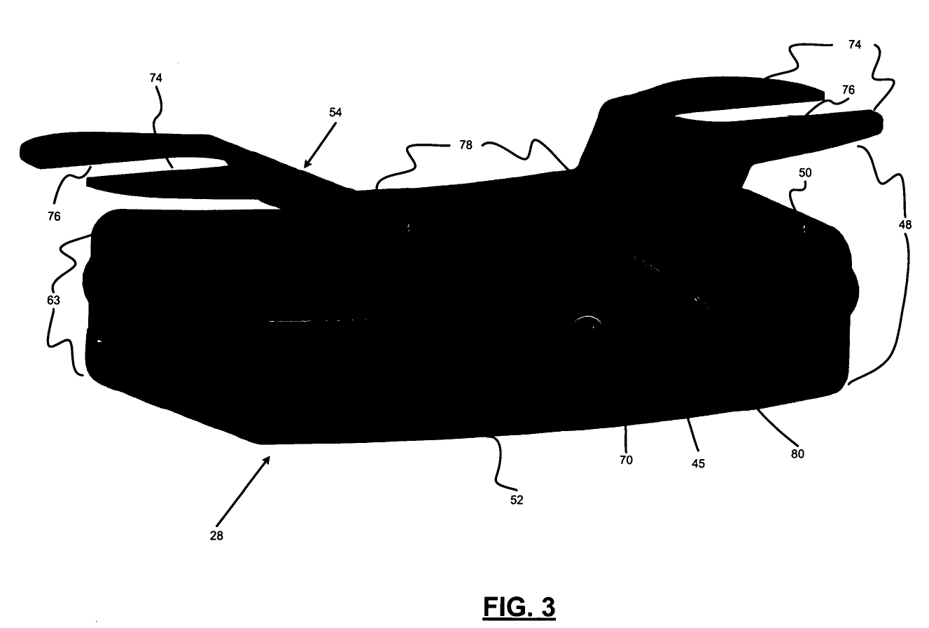

FIG. 4 is an exploded perspective view of components of the hydrant locator unit of the fire hydrant locating system; and

FIG. 5 is a side pictorial view of an upper portion of a fire hydrant with the hydrant locator unit fixed to a cylinder portion of the fire hydrant.

### DETAILED DESCRIPTION OF THE PREFERRED EMBODIMENTS

The following description of the preferred embodiment(s) is merely exemplary in nature and is in no way intended to limit the invention, its application, or uses.

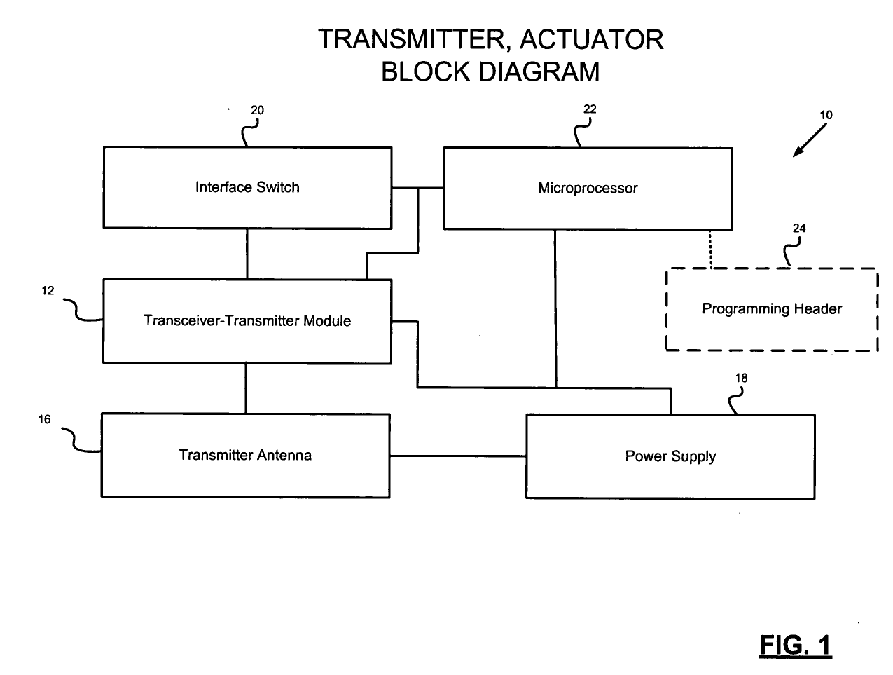

Looking now to FIG. 1, a block diagram is shown of the transmitter, actuator 10, of the fire hydrant locating system, and is adapted to be located in an emergency vehicle. Here the transmitter, actuator 10 includes an RF transceiver-transmitter module 12. In one form of the invention, the transceiver-transmitter module 12 is a transceiver which includes a transmitter section and a receiver section. However, also in one form of the invention, the transceiver-transmitter module 12 is connected only as a transmitter although it should be understood that it could also be connected as a receiver as well for different applications.

The transceiver-transmitter module 12 when actuated generates an RF signal. The output from the transceiver-transmitter module 12 is connected to an external transmitter antenna 16 for transmitting the amplified RF signal to hydrant locator units 28 on fire hydrants 32 to activate strobe lights to visually signal their locations. The transmitter antenna 16, which is of a conventional construction, is designed to transmit the RF signal generally in a forward direction for around 180°. The transceiver-transmitter module 12 is connected to and receives the necessary dc, direct current, voltage from a power supply 18 which in one form of the invention is the emergency vehicle's dc battery voltage supply system, e.g. 12v. It should be understood that this component could be designed to operate from different dc or ac (alternating current) supply sources.

The transmitter, actuator 10 also includes a microprocessor 22 which can be programmed at the factory site by a programming header 24 to perform the desired operations to be described. . In addition, the transceiver-transmitter module 12 can also be programmed to perform selected operations to be described. In this regard, the various operations of the microprocessor 22 can be programmed by the programming header 24 including to set the range of transmission of the transceiver-transmitter module 12 by controlling the power output. Since the programming header 24 is not a part of the transmitter, actuator 10 it is shown in dotted lines

An interface switch 20 is connected to the transceiver-transmitter module 12 and the microprocessor 22 and is set to be selectively actuated by an operator to activate the transceiver-transmitter module 12 and the microprocessor 22 to cause the system to transmit the RF signal in a desired manner In one form of the invention the interface switch 20 is a push button type switch which is activated only when pushed down momentarily by the operator and deactivated when released

The transmitter, actuator 10 can be selectively set by an operator installing a preselected program through the software in the programming header 24. As noted the selected program will actually be set in the microprocessor 22. Thus the microprocessor 22 as connected to the transceiver-transmitter module 12 will determine when it is activated to transmit the desired RF signal and when it is deactivated. In one form, as set, when the operator in the emergency vehicle presses the interface switch 20 to the closed condition, the microprocessor 22 will then activate the transceiver-transmitter module 12 to generate the RF signal for a preselected time. In one form, it would be activated for 8 to 10 seconds each time the interface switch 20 is closed by the operator.

It should be understood, that the microprocessor 22 could be programmed such that with activation of the interface switch 20 by a push button, the RF signal could be cyclically generated over a set time period, i.e. on-off cycles, i.e. “on” for 8 to 10 seconds and “off” for a preset time with the cycle repeating for a preset time and then being off until the next activation by the interface switch 20. The microprocessor 22 can be selectively programmed to provide a large variation in cycle times.

However, it should be understood that the microprocessor 22 could be set such that the on-off cycle will be repeated a preselected number of times with each activation of the interface switch 20. It should also be understood that a visual or audio signal could be provided to the operator after the cycle or set number of cycles ends.

It should be understood, however, that the interface switch 20 can be a toggle type switch that remains on until moved to off by the operator. Here, an audio or visual signal could be provided to the operator if the interface switch 20 is left in its on position after a preselected extended time, e.g., 15 or 20 minutes.

In one form, the transceiver-transmitter module 12 will be selected to generate a high frequency signal of around 900 to 950 MHz. To improve the range of transmission of the RF signal from the transceiver-transmitter module 12 the chip has an FSK element (frequency shift keying). This is a method of transmitting digital data by using a frequency for a logic “1” and a separate frequency for a logic “0”. The digital data is in an encrypted code that controls the microprocessor 38 in the receiver, locator 26 to start flashing when the RF signal from the transceiver-transmitter module 12 is received. The RF signal as transmitted from the transceiver-transmitter module 12, in one form of the invention, is set at 10 milli watts. An advantage of the FSK is that it is highly immune to electrical interference, allowing long range with low power.

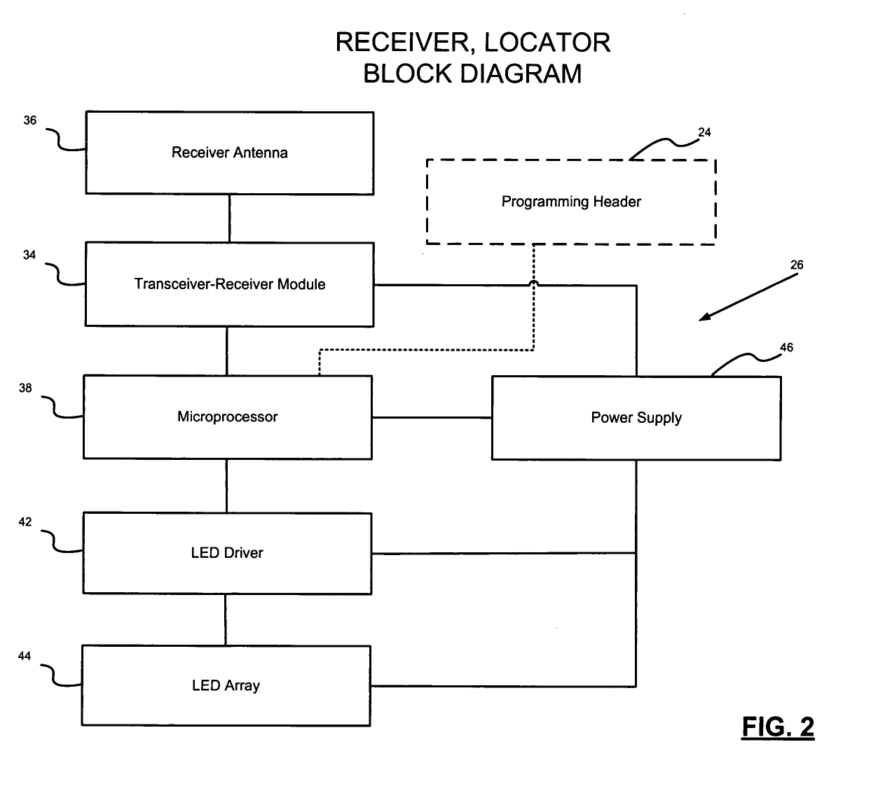

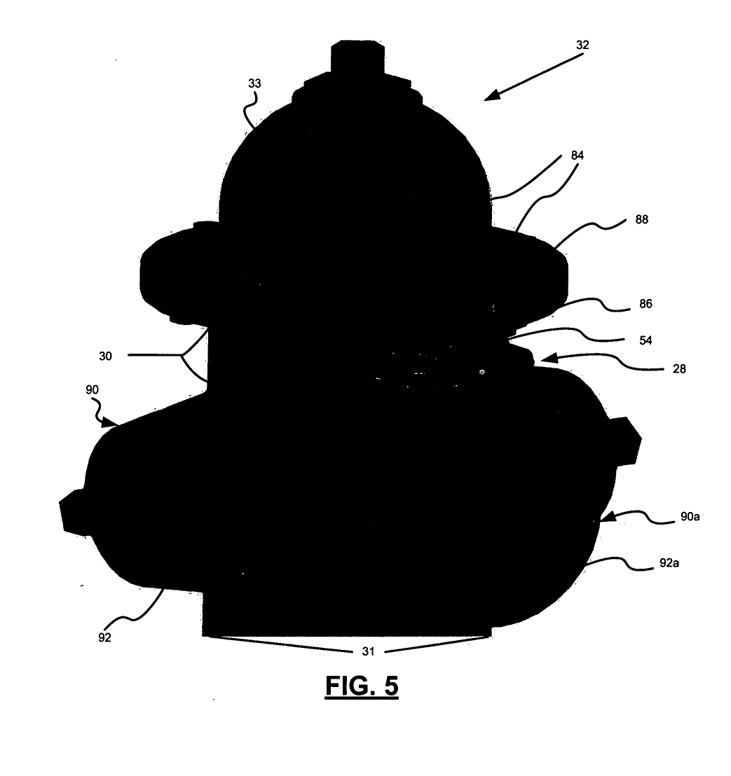

Looking now to FIG. 2 a block diagram of the receiver, locator 26 is shown which is in a hydrant locator unit 28 which is attachable to the top of a cylindrical neck 30 of the body portion 31 of a fire hydrant 32 below the crown 33 of the hydrant 32, as shown in FIGS. 5 and 6.

As noted the receiver, locator 26 has a transceiver-receiver module 34 which includes a transmitter section and a receiver section. However, in one form of the invention, the transceiver-receiver module 34 is connected only as a receiver although it should be understood that it could also be connected as a transmitter for different applications.

In this regard, it should be understood that the transceiver-transmitter module 12 could also be connected as a receiver and the transceiver-receiver module 34 could also be connected as a transmitter. In one modified system, once the hydrant locator unit 28 has been activated by an RF signal from the transmitter, actuator 10 it could be programmed to have the transmitter in the transceiver-receiver module 34 transmit an RF signal to the receiver in the transceiver-transmitter module 12 programmed to identify its location or other desirable information on a screen in the transmitter, actuator 10 in the emergency vehicle.

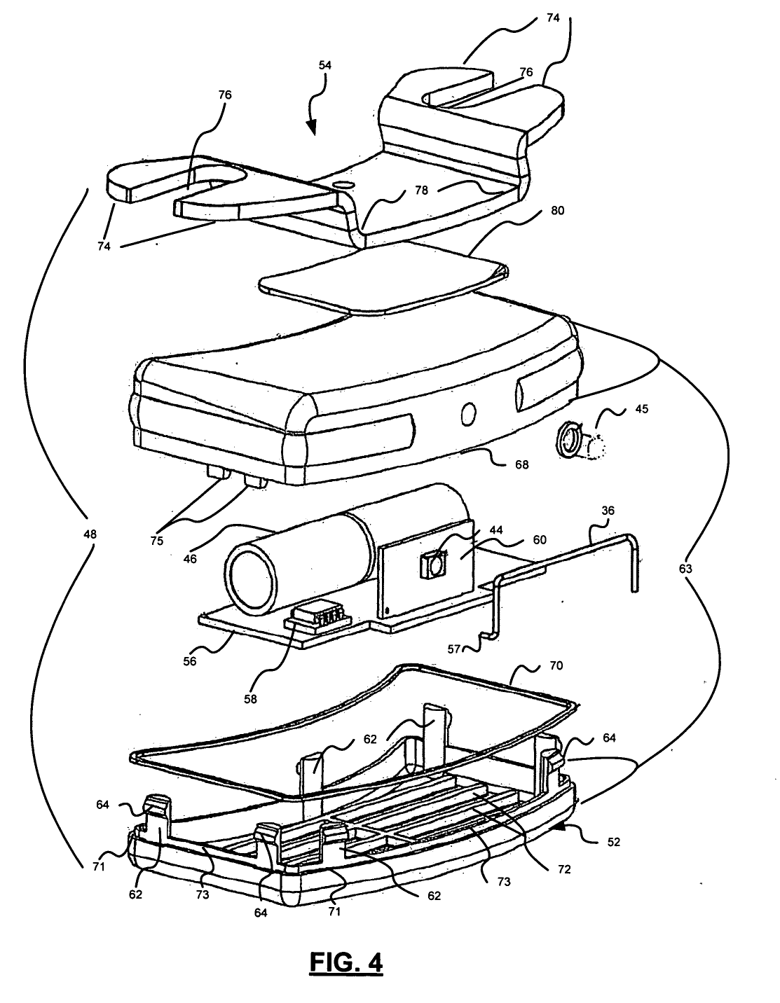

The receiver, locator 26 includes a receiver antenna 36 which is adapted to receive an RF signal from the transmitter, actuator 10 in the emergency vehicle. As can be seen in FIG. 4, in one form of the invention the antenna 36 is a wire antenna which is located internally in the hydrant locator unit 28 and is connected to a PCB, printed circuit board 56, which is only generally shown in FIG. 4. The receiver, locator 26 also includes a microprocessor 38 which can be programmed at the factory site by the software in the programming header 24 to perform desired operations to be described. In addition, the transceiver-receiver module 34 can also be programmed by the programming header 24 for desired operations. As noted before, since the programming header 24 is not a part of the receiver, locator 26 it is shown in dotted lines. The receiver antenna 36 is connected to a chip (not shown) on the transceiver-receiver module 34 on the printed circuit board 56 by a leg portion 57 to internally transmit the RF signals received from the transmitter, actuator 10.

When an RF signal is received from the transmitter, actuator 10, the transceiver-receiver module 34 is actuated to send a signal to the microprocessor 38. The microprocessor 38 is programmed then to provide control signals to an LED driver 42 which will then activate an LED array 44 of strobe lights to provide the light beam signals to visually identify its location to the operators of the emergency vehicles. The light from the LED array 44 will be transmitted out through a light pipe 45. The light pipe 45 will increase the intensity of the light through a lens system to then focus the light beam out at a generally hemispherical pattern. Here the LED array will be engaged with the light pipe 45 to facilitate efficient transmittal of the light beam.

The transceiver-receiver module 34, the microprocessor 38, LED driver 42 and LED array 44 receive the necessary dc voltage from a dc power supply 46 which in one form of the invention is a pair of lithium batteries.

In one form of the invention, the microprocessor 38 is programmed such that when it receives a signal from the transceiver-receiver module 34, it will control the LED array 44 to provide two light beam flashes per second for around four seconds followed by a brief pause of less than a second with the cycles being repeated for around two to four minutes. It will then be off unless another RF signal is received from the transmitter, actuator 10 in the emergency vehicle. However, the transceiver-receiver module 34 will be programmed to continuously have cycles of a sleep mode and a wake mode before any activation by the transmitter, actuator 10. In one form of the invention, the transceiver-receiver module 34 will be continuously cycled to be placed in a wake mode for around 10 milliseconds and a sleep mode for three to five seconds. This is controlled by the microprocessor 38 which is continuously on. Thus, it will always be cycled into a wake mode in a period to timely receive the RF signal from the transceiver-transmitter module 12 in its actuated, transmitting condition of eight to ten seconds. It should be understood that the system could be programmed to simply provide a light beam on and off without flashing while it is in the “on” or awake condition.

Such a controlled system is expected to provide the batteries in the power supply 46 with an expected life span of between seven to ten years.

It should be noted that certain units in the transmitter, actuator 10 and in the receiver, locator 26 are the same thus simplifying and minimizing the overall cost of the fire hydrant locating system.

Thus in one form, the transceiver-transmitter module 12 and transceiver-receiver module 34 were MICRF505 modules made by Micrel Inc. The microprocessors 22 and 38 were PIC12F509 made by Microchip Technology, Inc. The LED array 44 in the receiver, locator 26 was a model 61-25UWC/S400-A6/TR8 made by Everlight Electronics Co., Ltd. In one form of the invention the light pipe 45 was a model PLP5-125 made by Bivar Inc. The LED driver 42 in the receiver, locator 26 was a standard transistor. In one form of the invention the programming header 24 was a model MOLEX® BOARD. The model of the LED array 44, as noted above, has five LED chips whereby when actuated, it will provide a light beam of a high intensity. In addition, the high intensity of the light from the LEDs will be further intensified by the model of the light pipe 45, as noted above.

As noted, the hydrant locator unit 28 has a unique housing structure 48 as can be seen in FIG. 4. Thus the housing structure 48 has an upper housing member 50 and a lower housing member 52. A mounting bracket 54 is adapted to be secured to the top of upper housing member 50 for connection of the hydrant locator unit 28 to the fire hydrant 32 in a manner to be seen.

A circuit board 56 is adapted to be secured within the housing structure 48 and has the dc battery power supply 46 in a battery pack supported on it. The transceiver-receiver module 34, the microprocessor 38 and the LED driver 42 are also supported on the circuit board 56 at a preselected position as a circuit pad 58. The LED array 44 is held on to the circuit board 56 by way of a vertically extending support plate 60. The receiver antenna 36 is also adapted to be secured to the circuitry of the transceiver-receiver 34 on the circuit board 56. It can be seen that the circuit board 56 is only generally shown without any details of the circuit elements therein.

Let us now look to the unique features of the housing structure 48.

First, it should be noted that the upper housing member 50 and lower housing member 52 are removably secured together in a subassembly 63 by a plurality of resilient attachment fingers 62 extending upwardly from the upper end of the lower housing member 52. It can be seen in FIG. 4 that the fingers 62 are circumferentially distributed on the front, back and sides to provide a substantially uniform gripping action with the inner portion of the lower end of the upper housing member 50. The upper end of each of the fingers 62 has a locking tab 64. The locking tab 64 is outwardly protruding and is constructed to facilitate camming of the fingers 62 into a cavity in the inner side of the lower end of the upper housing member 50 with a snap fit. In one form, there is an internal annular ridge (not shown) on the inside of the lower end of the upper housing member 50 over which the fingers 62 snap to hold the housing members 50 and 52 together. However, because of the secure locking action provided by the tabs 64, tampering by removal of the lower housing member 52 will be resisted. Removal will be achieved by a designated operator with an unlocking tool different from common tools such as screw drivers, crow bars, etc.

An annular sealing gasket 70 as shown in FIG. 4 is located between the upper outer surface on a circumferential wall 73 of the lower housing member 52 and the lower outer surface 68 of the upper housing member 50. The gasket 70 is adapted to be compressively, resiliently engaged by the lower outer surface 68 of the upper housing member 50 to provide a desirable, tight seal. The sealing gasket 70 is initially located on a circumferential shoulder 71 of the lower housing member 52. The shoulder 71 extends outwardly from the inner, circumferential wall 73. The fingers 62 extend upwardly from the wall 73.

It can be seen in FIG. 5 that the lower housing member 52 has a plurality of ribs 72 on its bottom surface to reinforce the strength of the lower housing member 52. Similar reinforcing ribs (not shown) are located in the upper housing member 50. The circuit board 56 will be supported upon the ribs 72. Fingers 75 extending downwardly from the upper housing member 50 are adapted to engage the circuit board 56 to hold it firmly against the ribs 72 upon assembly.

Now with the upper housing member 50 and lower housing member 52 locked together, this housing subassembly 63 can now be secured to the mounting bracket 54. The mounting bracket 54 has oppositely extending securing flanges 74 with securement slots 76. A depressed center section 78 is located between the securing flanges 74.

The housing subassembly 63 can be secured to the depressed center section 78 by a rectangular bonding pad 80. The bonding pad 80 will be of substantially the same width and length as the bottom surface of the depressed center section 78. Now the mounting bracket 54 with the bonding pad 80 secured to the lower surface of the depressed center section 78 will be compressively engaged with the upper surface of the upper housing member 50. This will strongly hold the housing subassembly 63 and the mounting bracket together. In one form of the invention the bonding pad 80 was a double coated acrylic foam tape such as VHB 3M 4941 made by 3M. It bonds to the material on roughened surfaces by working into the microstructure of the surfaces and locking on to the sharp edges of the roughened surfaces. Also material of the bonding pad 80 has viscoelastic properties that allow it to take on literally any shape.

It can be seen in FIG. 6 that the hydrant locator unit 28 can now be secured to the hydrant 32 by two retaining bolts 84 extending through the usual mounting holes for bolting the hydrant crown 33 to the neck 30 via the annular, engaging flanges 86 and 88 on the neck 30 and crown 33, respectively. The retaining bolts 84 extend through the slots 76 in the securing flanges 74 to clamp the hydrant locator unit 28 to the hydrant flanges 86 and 88 on the neck 30 and crown 33. It can be seen that the bolts 84 are inserted in the same direction as the other retaining bolts to facilitate attachment of the hydrant locator unit 28. Of course, other attachment bolts or attachment structures could be used where desirable or required.

It can also be noted that the securing flanges 74 extend slightly past the housing subassembly 63 and that the depressed center section 78 locates the housing subassembly 63 in clearance below the retaining bolts 84. This facilitates assembly and disassembly of the hydrant locator unit 28 to the hydrant 32. In this regard, it can also be seen that the hydrant 32 has a plurality of water outlets 90 which are sealed by threadably removable caps 92. The outlets 90 are adapted to receive the fire hose. It is common for one of the water outlets 90a to be directed towards the street on which it is located. Here, the hydrant locator unit 28 is located above but in line with the water outlet 90a directed toward the street. This then provides the flashing light signal to be directed into the street to thereby facilitate detection by the operators in the fire truck (emergency vehicle) as it moves on that street. The locator unit 28 is in substantial clearance relationship with the cap 92a and the flange 86 on the neck 30. It should be understood that the hydrant locator unit 28 could be located at a position circumferentially spaced from the water outlet 90a and cap 92a. It should also be understood that in some situations, it may be desirable to have more than one hydrant locator unit 28 secured to a hydrant 32. Also there are hydrants, such as hydrant 32, with between one and four water outlets, such as outlet 90. Also, there are some hydrants, such as hydrant 32, that have water outlets, such as outlet 90, in the crown, such as crown 33. Hydrant locators of the present invention can be adapted to be operable with all such hydrants with a different mounting bracket 54.

It should also be noted, however, that there are hydrants of even other types of constructions. In such cases a mounting bracket, such as bracket 54, of a different design may be required for attachment. But in some instances the same housing structure 48 may be appropriate and since it is a separate member from the mounting bracket 54 it could be similarly attached to a modified mounting bracket by a flexible bonding pad, such as bonding pad 80. In this regard, the bonding pad 80 permits the location of the housing structure 48 on the mounting bracket 54 to be horizontally, angularly varied for different conditions to transmit the light beam in a selected horizontal direction. Also the bonding pad 80 could be used in an arrangement to selectively vary the vertical angular direction of the light beam. Thus it should also be noted that the present invention of the hydrant locator unit 28 could be utilized with different forms of housing structures and mounting brackets.

It should be noted that the operative condition of the hydrant locator unit could be periodically, manually monitored by a portable transmitter, actuator such as the transmitter, actuator 10. Also, the microprocessor 38 in the receiver, locator 26 could be programmed to monitor other conditions in the receiver, locator 26. These conditions could be for example the battery voltage of the power supply 46, the condition of the LED array 44, i.e. how many LEDs are still operative.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fire hydrant locating system for facilitating location of a hydrant in an emergency area by personnel in an emergency vehicle, said locating system including:
a hydrant locator unit adapted to be secured to a fire hydrant;
said hydrant locator unit including a receiver, locator secured in a housing which is adapted to be attached to the fire hydrant;
a transmitter, actuator adapted to be located in the emergency vehicle;
said transmitter, actuator including a transmitter being selectively actuable by an operator to transmit a radio frequency signal to assist in locating a fire hydrant near the emergency area;
said receiver, locator in said hydrant locator unit as attached to the fire hydrant including a receiver adapted to receive the radio frequency signal from said transmitter;
said receiver, locator including light emitting apparatus for transmitting a flashing light to signal the location of the hydrant locator unit and the associated hydrant,
said receiver, locator including a battery for providing power to the apparatus in said receiver, locator including said receiver and said light emitting apparatus,
said receiver, locator being programmed to cyclically energize said receiver to continuously cycle to be on in a wake mode for a preselected period to receive the radio frequency signal and off in a sleep mode for a preselected period,
upon receipt of a radio frequency signal by said receiver from said transmitter when in a wake mode said light emitting apparatus will be actuated to be on to provide a flashing light signal for a preselected time and then actuated to be off for a preselected time with the cycle being repeated for a preselected time.

2. The fire hydrant locating system of claim 1 with said transmitter, actuator being programmed to provide the radio frequency signal from said transmitter cyclically having a preset on time followed by a preset off time with the cycle being repeated over a preselected time period.

3. The fire hydrant locating system of claim 2 including a manual switch which when actuated will actuate said transmitter, actuator with said transmitter, actuator providing the noted cycles for the preselected time period after which it can be repeated by actuation of the manual switch.

4. The fire hydrant locating system of claim 1 with said light emitting apparatus including an array of a plurality of LEDs connected together as a unitary light source.

5. The fire hydrant locating system of claim 4 with said light emitting apparatus including a light pipe operatively connected to said plurality of LEDs to provide a light beam focused to provide a high intensity flashing light beam signal at a preselected angle.

6. The fire hydrant locating system of claim 1 with the hydrant having a body portion terminating in a cylindrical neck with a crown secured to the cylindrical neck by bolts extending through aligned openings in engaging flanges at the ends of the neck and crown;
said hydrant locator unit having a housing in which said receiver, locator is held, said housing of said hydrant locator unit having an attachment structure adapted to be removably secured to the engaging flanges by bolts extending through the aligned openings in the engaging flanges.

7. The fire hydrant locating system of claim 1 with said light emitting apparatus including a battery actuated light source and a light pipe operatively connected to said light source to provide a light beam focused to provide a high intensity flashing light beam signal at a preselected angle.

8. The fire hydrant locating system of claim 1 with said transmitter, actuator including a programmable unit adapted to be programmed to control the actuation of said transmitter to transmit the radio frequency signal in a predetermined manner.

9. The fire hydrant locating system of claim 1 with said receiver, locator including a programmable unit adapted to be programmed to control the actuation of said receiver to be cycled continuously to be on in the wake mode for the preselected period in order to receive the radio frequency signal and off in the sleep mode for the preselected period.

10. The fire hydrant locating system of claim 9 with said programmable unit programmed to control said light emitting apparatus to provide actuation of said light emitting apparatus to the on and off periods to provide said flashing light beam signal in a predetermined cyclic manner with the cycle being repeated for a preselected time during transmission of the radio frequency signal by said transmitter.

11. The fire hydrant locating system of claim 8 with said receiver, locator including a programmable unit adapted to be programmed to control the actuation of said receiver to be cycled continuously to be on in the wake mode for the preselected period and off in the sleep mode for the preselected period in order to receive the radio frequency signal.

12. The fire hydrant locating system of claim 11 with said programmable unit programmed to control said light emitting apparatus to provide actuation of said light emitting apparatus to provide actuation of said light emitting apparatus to the on and off periods to provide said flashing light beam signal in a predetermined cyclic manner with the cycle being repeated for a preselected time during transmission of the radio frequency signal by said transmitter.

13. The fire hydrant locating system of claim 12 with said light emitting apparatus including an array of a plurality of LEDs connected together as a unitary light source.

14. The fire hydrant locating system of claim 13 with said light emitting apparatus including a light pipe operatively connected to said plurality of LEDs to provide a light beam focused to provide a high intensity flashing light beam signal at a preselected angle.

15. The fire hydrant locating system of claim 12 with said light emitting apparatus including a battery actuated light source and a light pipe operatively connected to said light source to provide a light beam focused to provide a high intensity flashing light beam signal at a preselected angle.

16. The fire hydrant locating system of claim 1 with at least one of said transmitter and said receiver being a transceiver module which can be connected as a transmitter and/or a receiver.

17. The fire hydrant locating system of claim 11 with said programmable units each being selectively programmable by a common programming header.

18. The fire hydrant locating system of claim 1 with said transmitter, actuator adapted to activate said receiver, locator within a range of around 1500 feet.

19. The fire hydrant locating system of claim 1 with said receiver, locator energizing said receiver to be on in the wake mode for several seconds and to be off in the sleep mode for several seconds in order to preserve the life of said battery.

20. The fire hydrant locating system of claim 1 with said light emitting apparatus, when a radio frequency signal is received, being on to provide the flashing signal for several seconds and off for several seconds and with the flashing signal cycle being repeated for several minutes and then off from the flashing signal cycle until another radio frequency signal is received.

21. The fire hydrant locating system of claim 19 with said light emitting apparatus, when a radio frequency signal is received, being on to provide the flashing signal for several seconds and off for several seconds and with the flashing signal cycle being repeated for several minutes and then off from the flashing signal cycle until another radio frequency signal is received.

22. A fire hydrant locating system for facilitating location of a hydrant in an emergency area by personnel in an emergency vehicle, said locating system including:
a hydrant locator unit adapted to be secured to a fire hydrant;
said hydrant locator unit including a receiver, locator secured in a housing which is adapted to be attached to the fire hydrant;
a transmitter, actuator adapted to be located in the emergency vehicle;
said transmitter, actuator including a transmitter being selectively actuable by an operator to transmit a radio frequency signal to assist in locating a fire hydrant near the emergency area;
said receiver, locator in said hydrant locator unit as attached to the fire hydrant including a receiver adapted to receive the radio frequency signal from said transmitter;
said receiver, locator including light emitting apparatus for transmitting a light beam to signal the location of the hydrant locator unit and the associated hydrant,
said receiver, locator, including a battery for providing power to the apparatus in said receiver, locator including said receiver and said light emitting apparatus,
said receiver, locator being programmed to cyclically energize the receiver to continuously cycle to be on in a wake mode for a preselected period to receive a radio frequency signal from said transmitter, actuator and off in a sleep mode for a preselected period,
upon receipt of a radio frequency signal by said receiver from said transmitter when in a wake mode said light emitting apparatus will be actuated to be on to provide a light beam signal for a preselected time and then actuated to be off for a preselected time with the cycle being repeated for a preselected time.

23. The fire hydrant locating system of claim 22 with said transmitter, actuator adapted to activate said receiver, locator within a range of around 1500 feet.

24. The fire hydrant locating system of claim 22 with said receiver, locator energizing said receiver to be on in the wake mode for several seconds and to be off in the sleep mode for several seconds in order to preserve the life of said battery.

25. The fire hydrant locating system of claim 22 with said light emitting apparatus, when a radio frequency signal is received, being on to provide the flashing signal for several seconds and off for several seconds and with the flashing signal cycle being repeated for several minutes and then off from the flashing signal cycle until another radio frequency signal is received.

26. The fire hydrant locating system of claim 24 with said light emitting apparatus, when a radio frequency signal is received, being on to provide the flashing signal for several seconds and off for several seconds and with the flashing signal cycle being repeated for several minutes and then off from the flashing signal cycle until another radio frequency signal is received.

27. A fire hydrant locating system for facilitating location of a hydrant in an emergency area by personnel in an emergency vehicle, said locating system including:
a hydrant locator unit adapted to be secured to a fire hydrant;
said hydrant locator unit including a receiver, locator secured in a housing which is adapted to be attached to the fire hydrant;
a transmitter, actuator adapted to be located in the emergency vehicle and including a transmitter for selectively transmitting a radio frequency signal;
said receiver, locator in said hydrant locator unit as attached to the fire hydrant including a receiver adapted to receive the radio frequency signal from said transmitter;
said receiver, locator including light emitting apparatus for transmitting a light beam to signal the location of the hydrant locator unit and the associated hydrant,
the hydrant having a body portion terminating in a cylindrical neck with a crown secured to the cylindrical neck by bolts extending through aligned openings in engaging hydrant flanges at the ends of the neck and crown;
said hydrant locator unit having a housing structure in which said receiver, locator is held, said housing structure having an attachment structure adapted to be removably secured to the engaging hydrant flanges by bolts extending through the aligned openings in the engaging flanges.

28. The fire hydrant locating system of claim 27 with said housing structure including a housing subassembly with said receiver and said light emitting apparatus located therein, said attachment structure connected to said housing by a flexible bonding pad.

29. The fire hydrant locating system of claim 28 with said attachment structure having axially oppositely extending securing flanges having openings adapted to receive said bolts through the hydrant flanges to secure said receiver locator to the engaging hydrant flanges.

30. The fire hydrant locating system of claim 28 with said housing subassembly including an upper housing member and a lower housing member secured together by fingers extending transversely from one of the housing members and adapted to be moved into locking engagement with the other housing member.

31. The fire hydrant locating system of claim 29 with said housing subassembly including an upper housing member and a lower housing member secured together by fingers extending transversely from one of the housing members and adapted to be moved into locking engagement with the other housing member.

32. The fire hydrant locating system of claim 27 with said transmitter, actuator adapted to activate said receiver, locator within a range of around 1500 feet.

33. The fire hydrant locating system of claim 27 with said attachment structure having axially oppositely extending securing flanges having openings adapted to receive said bolts through the hydrant flanges to secure said receiver locator to the engaging hydrant flanges,
said housing subassembly including an upper housing member and a lower housing member secured together by fingers extending transversely from one of the housing members and adapted to be moved into locking engagement with the other housing member,
said housing subassembly including an upper housing member and a lower housing member secured together by fingers extending transversely from one of the housing members and adapted to be moved into locking engagement with the other housing member.

34. A fire hydrant locating system for facilitating location of a hydrant in an emergency area by personnel in an emergency vehicle, said locating system including:
a hydrant locator unit adapted to be secured to a fire hydrant;
said hydrant locator unit including a receiver, locator secured in a housing which is adapted to be attached to the fire hydrant;
a transmitter, actuator adapted to be located in the emergency vehicle;
said transmitter, actuator including a transmitter being selectively actuable by an operator to transmit a radio frequency signal to assist in locating a fire hydrant near the emergency area;
said receiver, locator in said hydrant locator unit as attached to the fire hydrant including a receiver adapted to receive the radio frequency signal from said transmitter;
said receiver, locator including light emitting apparatus for transmitting a light beam to signal the location of the hydrant locator unit and the associated hydrant,
said receiver, locator being programmed to cyclically energize the receiver to continuously be on in a wake mode for a preselected period to receive a radio frequency signal from said transmitter, actuator and off in a sleep mode for a preselected period,
upon receipt of a radio frequency signal by said receiver from said transmitter when in a wake mode said light emitting apparatus will be actuated to be on to provide a light beam signal for a preselected time and then actuated to be off for a preselected time with the cycle being repeated for a preselected time.

35. The fire hydrant locating system of claim 34 with said transmitter, actuator adapted to activate said receiver, locator within a range of around 1500 feet.

36. The fire hydrant locating system of claim 34 with said light emitting apparatus including an array of a plurality of LEDs connected together as a unitary light source.

37. The fire hydrant locating system of claim 36 with said light emitting apparatus including a light pipe operatively connected to said plurality of LEDs to provide a light beam focused to provide a high intensity flashing light beam signal at a preselected angle.

38. The fire hydrant locating system of claim 34 with said receiver, locator energizing said receiver to be on in the wake mode for several seconds and to be off in the sleep mode for several seconds.

39. The fire hydrant locating system of claim 34 with said light emitting apparatus, when a radio frequency signal is received, being on to provide the flashing signal for several seconds and off for several seconds and with the flashing signal cycle being repeated for several minutes and then off from the flashing signal cycle until another radio frequency signal is received.

40. The fire hydrant locating system of claim 38 with said light emitting apparatus, when a radio frequency signal is received, being on to provide the flashing signal for several seconds and off for several seconds and being repeated for several minutes and then off until another radio frequency signal is received.

41. A fire hydrant locating system for facilitating location of a hydrant in an emergency area by personnel in an emergency vehicle, said locating system including:
a hydrant locator unit adapted to be secured to a fire hydrant;
said hydrant locator unit including a receiver, locator secured in a housing which is adapted to be attached to the fire hydrant;
a transmitter, actuator adapted to be located in the emergency vehicle;
said transmitter, actuator including a transmitter being selectively actuable by an operator to transmit a radio frequency signal to assist in locating a fire hydrant near the emergency area;
said receiver, locator in said hydrant locator unit as attached to the fire hydrant including a receiver adapted to receive the radio frequency signal from said transmitter;
said receiver, locator including light emitting apparatus for transmitting a flashing light to signal the location of the hydrant locator unit and the associated hydrant,
said receiver, locator being programmed to cyclically energize the receiver to continuously cycle to be on in a wake mode for a preselected period to receive the radio frequency signal and off in a sleep mode for a preselected period,
upon receipt of a radio frequency signal by said receiver from said transmitter when in a wake mode said light emitting apparatus will be actuated to be on to provide a flashing light signal for a preselected time and then actuated to be off for a preselected time with the cycle being repeated for a preselected time.

42. The fire hydrant locating system of claim 41 with said transmitter, actuator being programmed to provide the radio frequency signal from said transmitter cyclically having a preset on time followed by a preset off time with the cycle being repeated over a preselected time period.

43. The fire hydrant locating system of claim 41 with said light emitting apparatus including an array of a plurality of LEDs connected together as a unitary light source.

44. The fire hydrant locating system of claim 43 with said light emitting apparatus including a light pipe operatively connected to said plurality of LEDs to provide a light beam focused to provide a high intensity flashing light beam signal at a preselected angle.

45. The fire hydrant locating system of claim 41 with said light emitting apparatus including a battery actuated light source and a light pipe operatively connected to said light source to provide a light beam focused to provide a high intensity flashing light beam signal at a preselected angle.

46. The fire hydrant locating system of claim 41 with said receiver, locator including a programmable unit adapted to be programmed to control the actuation of said receiver to be cycled continuously to be on in the wake mode for the preselected period and off in the sleep mode for the preselected period.
